(19) United States
(12) Patent Application Publication
(10) Pub. No.: US 2004/0225539 A1
(43) Pub. Date: Nov. 11, 2004

(54) Itinerary optimizer

(75) Inventors: James G. Pilaar, San Francisco, CA (US); John L. Taylor, San Francisco, CA (US); Ben Scarola, Portland, OR (US); Anne Beug, Berkeley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Airtreks, Inc., San Francisco, CA (US)

(21) Appl. No.: 10/778,938

(22) Filed: Feb. 12, 2004

Related U.S. Application Data
(63) Continuation-in-part of application No. 09/539,658, filed on Mar. 30, 2000.

(51) Int. Cl. G06F 17/60

(52) U.S. Cl. 705/5

(57) ABSTRACT

A method of generating an itinerary using a computer is provided. The itinerary includes nodes that represent a location serviced by scheduled transport services. A specification including a plurality of nodes is received. The specification may be in a specified order. An itinerary is then determined where a first fare is calculated that omits a node in the plurality of nodes received. A second fare is then calculated that includes the node omitted in the first fare. Thus, an itinerary that includes fares for each of the plurality of nodes is calculated; however, a fare is calculated that does not include a node in the plurality of nodes and thus does not adhere to the specified ordering of the plurality of nodes received.

### CROSS-REFERENCES TO RELATED APPLICATIONS

This application is a continuation-in-part application of U.S. patent application Ser. No. 09/539,658, filed Mar. 30, 2000, which is herein incorporated by reference in its entirety for all purposes.

### FIELD OF THE INVENTION

The present invention relates generally to a process and apparatus for identifying a path among nodes and in particular for finding an itinerary given a desired route in a specified order through a selection of cities.

### BACKGROUND OF THE INVENTION

With the advent of computers connected to airline reservations systems and the availability of online booking systems, travelers have easy methods of optimizing point to point travel. For example, a traveler (specifically, an “itinerant” or one who follows an itinerary) can connect to a travel server and request the lowest fare for a flight from city A to city B subject to one or more constraints (i.e., flight dates, airlines, class of service, number of intermediate stops, etc.). Although the travel servers optimize well for point-to-point travel, they cannot optimize for routes having many destinations and where the destinations might be spread over multiple continents.

Conventionally, a user submits a route of cities in a specified order, such as A-B-C-D. A travel server is then restricted to searching for fares that cover all the user's cities in the specified order. For example, fares for the routes A-B, A-B-C, A-B-C-D, B-C, B-C-D, and so forth may be calculated. In some cases, however, trying to find fares in the specified order of a route received from the user results in high or undesirable fares.

Accordingly, techniques are desired for finding fares for routes that do not adhere to the specified ordering of a route received from a user.

### BRIEF SUMMARY OF THE INVENTION

Embodiments of the present invention generally relate to determining a desired route through a plurality of cities where a city in the route is omitted in one fare but included in another fare.

In one embodiment, a method of generating an itinerary using a computer is provided. The itinerary includes nodes that represent a location serviced by scheduled transport services. A specification including a plurality of nodes is received. In one embodiment, the specification may be in a specified order. An itinerary is then determined where a first fare is calculated that omits a node in the plurality of nodes received. A second fare is then calculated that includes the node omitted in the first fare. Thus, an itinerary that includes fares for each of the plurality of nodes is calculated; however, a fare is calculated that does not include a node in the plurality of nodes and thus does not adhere to the specified ordering of the plurality of nodes received.

A method of generating an itinerary using a computer is provided. The itinerary includes nodes each representing a location accessible by a scheduled transport service. The method comprises: receiving a specification including a plurality of nodes; determining an itinerary that includes a first fare that omits at least one node in the plurality of nodes; and determining a second fare that includes the node omitted in the first fare and a node included in the first fare.

A method for generating an itinerary using a computer is provided. The itinerary includes nodes each representing a location accessible by a scheduled transport service. The method comprises: receiving a specification of a plurality of nodes, the plurality of nodes specified in an order of destination; determining a first fare that omits a node in the plurality of nodes, the first fare including a sequence of nodes that are not in the order specified; and determining a second fare that includes the omitted node and a node in the first itinerary.

A method for generating an itinerary using a computer is provided. The itinerary includes nodes each representing a location accessible by a scheduled transport service. The method comprises: receiving a specification of a plurality of nodes, the plurality of nodes specified in an order of destination; determining a first fare that includes nodes that are not in the specified order; and determining a second fare that includes a node that was skipped in the first itinerary.

A method for generating an itinerary using a computer is provided. The itinerary includes nodes each representing a location accessible by a scheduled transport service. The method comprises: receiving a specification of a plurality of nodes; determining, from nodes in the plurality of nodes, a replacement node that may replace a node in the plurality of nodes; and calculating a fare for an itinerary that includes the replacement node instead of the replaced node in the specification.

A further understanding of the nature and the advantages of the inventions disclosed herein may be realized by reference of the remaining portions of the specification and the attached drawings.

### BRIEF DESCRIPTION OF THE DRAWINGS

FIG. 1 is a block diagram of a client-server system interfacing users and an itinerary optimizer.

FIG. 2 is a block diagram showing the itinerary optimizer of FIG. 1 in greater detail.

FIG. 3 is a data diagram illustrating one example of a database used for processing itineraries.

FIG. 4 is a block diagram of a system using an itinerary optimizer that uses certainty values in processing itineraries.

FIG. 5 depicts an embodiment of itinerary optimizer according to embodiments of the present invention.

FIG. 6 depicts a simplified flow chart of a method for determining an itinerary according to one embodiment of the present invention.

Appendix A is a source code listing for a fare finder module and Appendix B is a source code listing for a fare scoring module.

### DETAILED DESCRIPTION OF THE INVENTION

Specific embodiments of an itinerary optimizer according to the present invention are described herein. Others may become apparent after reading this description and it should be understood that the invention is not limited to these specific examples, but is limited only by the appended claims. Furthermore, while specific methods and apparatus are shown, it should be apparent upon reading this disclosure that some of the methods can be practiced using different apparatus and the apparatus shown could be used to perform different methods than shown.

This description discloses how to make and use several embodiments of a system according to the present invention, but for brevity omits descriptions of many well-known components of such systems. For example, the operation and design of a standard internet and the like are not explicitly disclosed herein, as they well described in countless readily available sources.

In the description below, like elements of the figures are referenced with like numbers. Distinct instances of like elements might be referenced with like numbers followed by distinct instance numbers in parentheses.

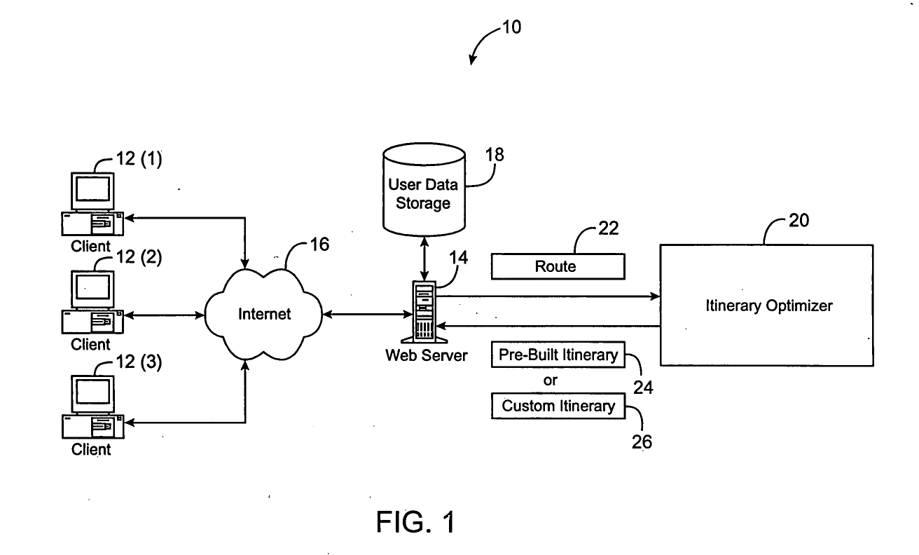

FIG. 1 is a block diagram of a client-server system 10 that might be used as an interface between users and an itinerary optimizer, such as the itinerary optimizer 20 shown in FIG. 1. In system 10, various client computers or computing devices (clients) 12 are coupled to a web server 14 via a network 16. The operation and arrangement of clients 12, web server 14 and network 16 could be according to conventional techniques for interfacing web browsers to web servers. In such a system, web server 14 would present web pages to clients 12 upon request and provide prompting pages to the browser at client 12 in order to prompt a user of the browser to enter information about the user's requirements, demographic information and destination interests. Such interaction could be done using conventional hypertext interaction, such as the sending and receiving of hypertext transport protocol (HTTP) “pages” as is well known.

Other portions of system 10 would be unconventional, but could be interfaced to web server 14 using readily available technology. For example, user data storage 18 is provided to store the data received from users via clients 12. An itinerary generation process might be triggered when a user indicates on an HTTP form that the user desires an itinerary generated from information previously provided by the user. Upon detecting such a selection, web server 14 would prompt itinerary optimizer 20 to begin the process of optimizing. Alternatively, the optimization process might be performed as an interactive process, with itinerary optimizer 20 interacting with the user.

As shown in FIG. 1, web server 14 provides routes 22, which web server 14 can obtain from the stored user data in storage 18 and/or obtained from a user's selection at client 12. Alternatively, web server 14 might simply prompt itinerary optimizer 20 to begin and itinerary optimizer 20 could obtain routes 22 directly from user data storage 18. Of course, web server 14 and itinerary optimizer 20 could be processes running on the same computer, assuming the computer is powerful enough to perform the optimizations at the same time as serving pages to clients upon request.

Once itinerary optimizer 20 completes the process of generating one or more optimal itineraries, itinerary optimizer 20 provides those itineraries to web server 14 as either a pre-built itinerary 24 or a custom itinerary 26 and web server 14 would format the itinerary into one or more HTML page and provide the one or more HTML page to a browser program at client 12. The browser program at client 12 can then generate a display for the user showing the optimal itinerary calculated from the user's preferences and indications of destinations and certainty values. As explained below, in some variations of an itinerary optimizer, certainty values are used in the optimization process, but they are not required in other variations. Also, in some variations, side trips are used in the optimizer process, but they are not required in other variations.

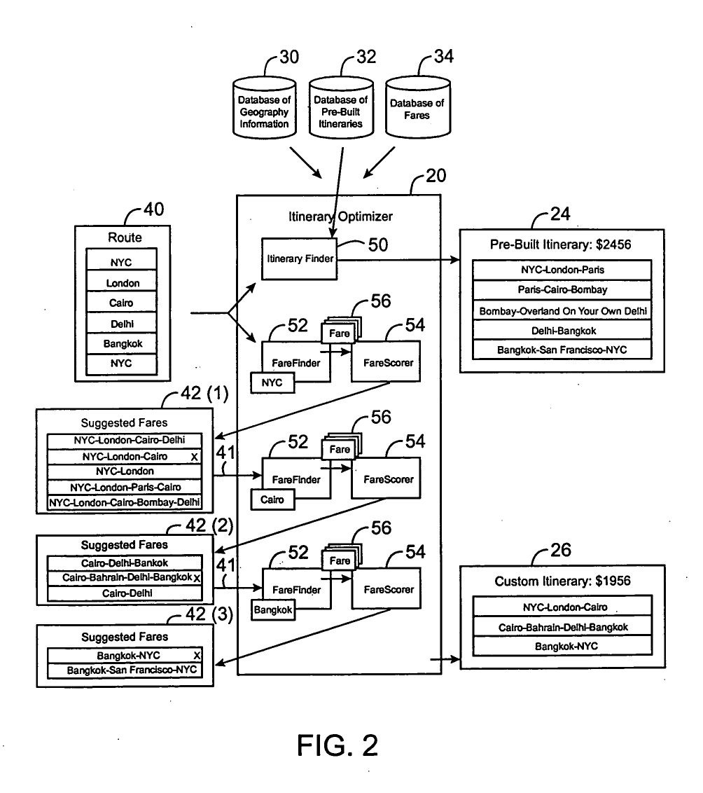

FIG. 2 is a block diagram of system 10 showing greater details of itinerary optimizer 20. The user could be either a human user interacting with the system or a computer user providing data to the system. As shown in FIG. 2, itinerary optimizer 20 is coupled to several databases, such as a geographic information database 30, a pre-built itineraries database 32 and a fares database 34. As shown, the inputs to itinerary optimizer 20 include a route 40 and selections 41 from among lists 42 of suggested fares, as well as the databases 30, 32, 34. One output from itinerary optimizer 20 is an itinerary, typically in the form of a pre-built itinerary 22 or a custom itinerary 26.

As shown in FIG. 2, a route 40 is applied to an itinerary finding module 50 and a fare finding module 52. If a matching pre-built itinerary exists in database 32, it is output as pre-built itinerary 24. Otherwise, segments 56 matching part of route 40 are output by fare finding module 52 to be inputs to a fare scoring module 54. Fare scoring module 54 outputs a list 42 of suggested fares, with one or more (and sometimes zero) selections flagged as optimal selections. A user can interactively select a segment from list 42 (1) and that segment is applied to fare finding module 52 with a new starting point (the end of the selected segment). Note that although FIG. 2 shows three instances of fare finding module 52 and fare scorer module 54, only one instance is needed. If the user's selections 41 match the suggested selections, the resulting output is custom itinerary 26 as shown.

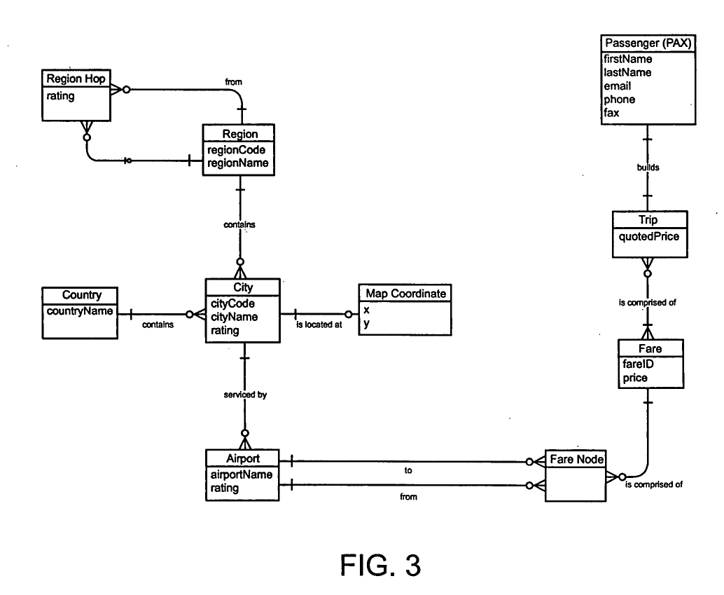

Referring now to FIG. 3, a database structure is there shown. One embodiment of a logic process for a fare finding module and for a fare scoring module is shown by the source code included as Appendices A and B.

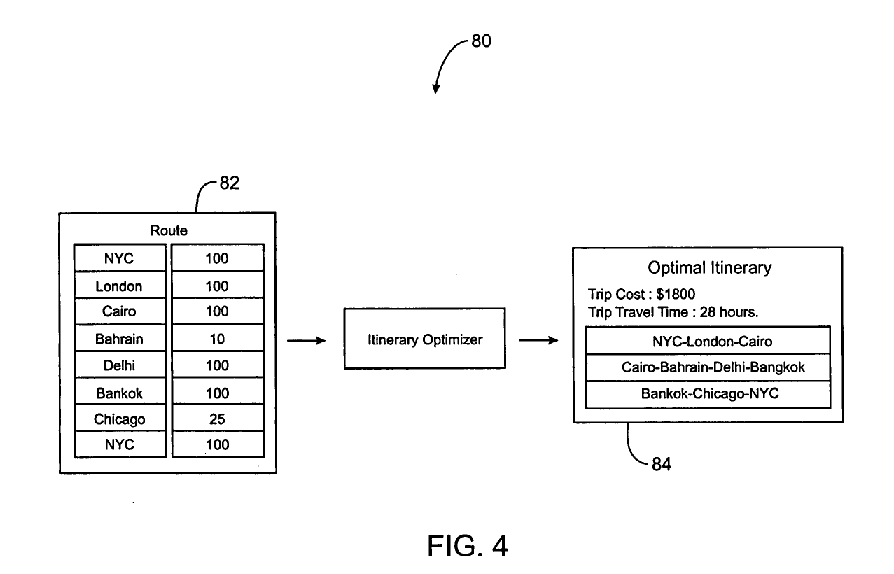

Referring to FIG. 4, an embodiment of an itinerary optimizer system 80 that optimizes a route 82 to find an optimal itinerary 84 is there shown. Certainty values for nodes of a route are used to generate an optimal itinerary. For example, one process of optimization might first sort the route nodes by certainty values placing the destinations for all indications onto the itinerary if the indications had certainty values of 100. The next step in the process might be sorting the destinations in the itinerary based on longitude or other distance metric. Then, once the certain destinations are included in the itinerary and sorted, then each of the less certain destinations would be added, one at a time, to the itinerary but omitted if the one itinerary were to change the total travel time or total airfare by more than some percentage of the previous total. After first pass of adding destinations and possibly excluding some destinations with certainties of less than 100, the unincluded destination indications are revisited and added to the itinerary between two other destination nodes, but only if the addition of the previously unused node results in an increase of less than some percentage in the total airfare costs.

Other, more complex and sophisticated optimization processes can be performed and can include user interaction, with or without the user having to specify certainty values in advance. The certainty values for the indications represent the relative requirements of the inputting user. For example, if the user only wants to consider itineraries which must have London as a destination, the certainty value for that indication of London as a destination might have a certainty value of 100, whereas a somewhat more optional destination might have a certainty value of 10, i.e., higher values represent higher certainty.

In one embodiment, itinerary optimizer 20 may include a side trip finder. A side trip finder allows itinerary optimizer 20 to skip over a destination node in a route in a specified order when searching for fares as long as another companion fare covers the skipped nodes.

FIG. 5 depicts an embodiment of itinerary optimizer 20 according to embodiments of the present invention. Itinerary optimizer 20 includes a side trip finder 502 that receives a route 504 and outputs a suggested itinerary 506.

Route 504 includes a plurality of destination nodes received from a user. Destination nodes may be stop points, end points, or stopovers for any fare calculation. In one embodiment, route 504 includes destination nodes that are, for example, in a specified order (e.g., A-B-C-D). In one embodiment, an ordering is a sequence of nodes that follow one after another. For example, if a route is London-New Delhi-Tokyo-Hong Kong, the order proceeds sequentially from left to right.

Side trip finder 502 may determine fares that do not adhere to the specified ordering. For example, the fares may omit a node in specified route 504. For example, if a specified ordering is A-B-C-D, a fare may include a route for the nodes A-C-D and omit the node B. However, side trip finder 502 may search for a fare that includes the omitted node B and a node found in the fare for nodes A-C-D, such as a node adjacent to (i.e., before or after) the omitted node. For example, a side trip may be C-B-C. Accordingly, the first fare for a route A-C-D does not adhere to the specified ordering thus requiring a user to travel from node A to node C instead of traveling from node A to node B to node C. However, after a user travels from node A to node C, another fare for a route C-B-C would include the node B and also bring the user back to node C. It will be understood that the fares may include additional nodes or helper cities not found in route 504. For example, nodes that may be layovers, stop overs, etc. may be added to a route for a fare. The helper cites may be inserted in a side trip fare or in a route that omits a city from route 504. Traveling to these cities is optional but the cities may help in calculating fares by making them cheaper.

If nodes in route 504 are considered cities, or areas that include scheduled transport services, side trip finder 502 may determine any cities that may be possibly omitted. These cities include any cities that may be omitted or skipped in determining fares for route 504. Even though the cities are skipped in determining a first fare, a second fare is determined that includes the omitted cities. The second fare may be a round trip route or more complex, such as going from a first city to a first airport in a second city and returning from a second airport in the second city to the first city. Additionally, different transport sevices may be used, such as airport service from nodes C-B and train service from nodes B-C.

As shown in suggested itinerary 506, two suggested itineraries #1 and #2 are provided. Although two are shown, it will be understood that other combinations may be provided.

As shown in suggested itinerary #1, fares for the route for nodes A-C-D are determined. This fare has omitted the destination node B in its calculation. Thus, the specified order of route 504 has not been adhered to because a fare from nodes A-C has been calculated without including node B. However, a side trip fare has been calculated for a route for nodes C-B-C. In one embodiment, a fare for a route for nodes C-B₁-B₂-C may also be calculated. B₁ and B₂ may be two different transport services for the same node or city. The two different transport services may be two different airports, an airport and a train service, etc. The side trip fares for routes C-B-C and C-B₁-B₂-C return back to the starting city. Thus, fare 1(a) may be used because side trip fares 1(b) or 1(c) are used to include any omitted nodes.

Another possibility for an itinerary may be suggested itinerary #2, where a fare 2(a) for a route A-B-D omits the destination node C. However, a side trip fare 2(b) of B-C-B is calculated. In this itinerary, a user would fly to the cities A-B-C-B-D. In this case, a fare is calculated with an omitted city even though it appears that the ordering of travel may be the same (if the trip the second time to node B is ignored). However, a fare for A-B-D omits the city C from the specified ordering. Although the itinerary may include an extra stop in the node B, the fare for nodes A-B-D when combined with the fare for nodes B-C-B may be more desirable than a fare calculated in the specified order A-B-C-D because the fares for nodes A-B-D may be considerably less than fares calculated to adhere to the ordering of nodes A-B-C-D.

Although the examples described show that one destination node is omitted from a fare, it will be understood that multiple cities may be omitted. Also, additional cities may be added to a side trip fare. For example, if a route is A-B-C-D-E-F, a fare for the route A-B-E-F may be calculated along with a side trip fare for the route B-C-D-B. Also, the side trip fare may add different cities not mentioned in the original route, such as a fare for the route B-C-Z-D-B, etc.

FIG. 6 depicts a simplified flow chart 600 of a method for determining an itinerary according to one embodiment of the present invention. In step 602, a route is received. The route specifies a plurality of destination nodes in a specific ordering.

In step 604, it is determined if a city of a destination node in the route may be skipped. Omitted cities may be any cities that correspond to destination nodes that might be skipped. The omitted cities may then be included in side trip fares from a destination node in the route.

In step 606, a fare for a route that is not in the order specified in step 602 is determined. For example, the fare may omit a node from the route received in step 602.

In step 608, a side trip fare that includes the node that was omitted is determined. The side trip fare also completes the route received in step 602. Thus, the fare computed in step 606 omits a destination node in the received route but the side trip fare includes the omitted destination node. The side trip fare may be a round trip fare or a fare that includes more than two cities from a node in the route determined in step 608.

In step 610, the fares for the routes determined in steps 606 and 608 are outputted. In one embodiment, multiple fares and routes may be determined and outputted to a user. A user may then select certain routes and the process may continue where different fares and routes are calculated based on a user selection. For example, different fares with different destination nodes skipped may be outputted and when one is selected, different side trip fares are calculated for the selected fare and route.

An example using embodiments of the present invention will now be described. A user request may be received for the cities in the order of New York-Dublin-London-Delhi. Side trip finder 502 may find a fare from New York-London-Delhi in addition to adding a round trip from London-Dublin-London. Thus, the fare for New York-London-Delhi omits Dublin; however, a fare from London-Dublin-London was added. Conventionally, a travel server would have to find fares from New York-London, London-Dublin-London, and London-Delhi because the server could not skip the city Dublin in searching for fares.

In one embodiment, side trip finder 502 may use certainty values as described above to determine fares. For example, certainty values may be used to determine which cites to skip in determining a fare. Additionally, embodiments described above that determine itineraries using certainty values may use side trip finder 502 to determine fares. For example, a desired route may be San Francisco(certainty=100)-Dublin(certainty=10)-London(certainty=90)-Delhi(certainty=100)-Bangkok(certainty=100). Dublin has a low certainty value of 10 and itinerary Optimizer 20 might consider that node as the best candidate to skip over. In this case, a side trip with Dublin in it may be generated. Also, because the certainty value is low, Dublin may be entirely omitted from a fare.

In another embodiment of the present invention, itinerary optimizer 20 may determine “major hubs” that may be used to replace destination nodes in a route. The major hub may be a city or destination node that may be more serviced than a smaller city that is included in the route. Thus, a savings of hundreds of dollars may be realized if a major hub is substituted for a city in the route.

For example, a desired route may be San Antonio-Dublin-Barcelona-Delhi. The fares for routes using the cities San Antonio, Dublin and Barcelona may result in an expensive fare because these cities may not be cities that are more serviced for travel. Instead of building an itinerary using these cities, major hubs may be determined and fares calculated using the major hubs instead of the specified destination nodes. For example, Houston, London, and Madrid may be major hubs that may be used to replace San Antonio, Dublin, and Barcelona, respectively. The major hubs are cities that, when included in a fare, may result in a lower fare than if the smaller or more remote city was used. Accordingly, an itinerary may be Houston-London-Madrid-Delhi with San Antonio, Dublin, and Barcelona omitted from the fares calculated.

The itinerary does not have to include all major hubs determined. For example, Dublin may be used instead of London if the change in value is slight. Also, certainty values may be specified and used to determine which cities are omitted for major hubs.

Although itinerary optimizer replaces cities with major hubs, the replaced cities may be included using side trips. For example, a side trip from Madrid-Barcelona-Madrid may be calculated to include Barcelona. In one example, a train service from Madrid-Barcelona-Madrid may be cheaper than a direct flight from San Antonio/Houston to Barcelona. Also, a side trip from Madrid-Barcelona-Madrid may be cheaper than flight from San Antonio/Houston to Barcelona.

An itinerary optimizer can be implemented by dedicated hardware, but the preferred embodiment is likely to be in the form of a general purpose computer programmed with instructions to carry out an optimization process such as a process described herein. An example of such a process is illustrated in Appendices A and B.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope of equivalents.

APPENDIX A

| | |
|---|---|
| Set workingRoute = deep copy of current route | |
| Set currentCityOffset = index of last visited instance of currentCity | \ |
| (either as city, or overlandCity) in the currentRoute | |
| If currentCity is not in the route | |
| set currentCityOffset to the index of the last visited node | |
| If it is the first time through the route | |
| set currentCityOffset to 0 | |
| If currentCityOffset is not at the end of the route | |
| If (currentCity,nextCity) or (currentRegion,nextRegion) have an entry | \ |
| in the movementProblems hash table | |
| Create a new route node based on the solution city | |
| Insert the solution node between the current city and the next city | |
| If the current City's region is not the same as the region of the first city in the route | \ |
| and is not the first city in the route | |
| toBeScored = all fares starting in the current city, containing one of the next two | \ |
| unvisited regions, and one of the next N unvisited cities | \ |
| (where N is static MAX_CITY_MATCH) | |
| if toBeScored contains < 10 fares | |
| toBeScored = all fares starting in the current city and containing at | \ |
| least one unvisited city | |
| if toBeScored contains < 5 fares | |
| toBeScored = all fares starting in the current city | |
| else | |
| toBeScored = all fares starting in the current city and containing at least one | \ |
| unvisited city | |
| for each fare in faresToBeScored { | |
| scoreFare(currentFare, workingRoute) | |
| increment currentFareCount | |
| add curentFare and its score to resultFares | |
| } | |
| return resultFares | |

APPENDIX B
NUMERICAL CONSTANTS

| | |
|---|---|
| MAX_HOP_COUNT | Maximum allowable difference |
| | between hopCount(previous |
| | region, next region) before |
| | penalization will occur |
| MATCH | A unvisited instance of a city |
| | exists in the route |
| OVERLAND_IN_FARE | Fare contains an overland “000” |
| SKIPPED_ROUTE_NODE | A city was skipped in the |
| | original route |
| AVOID_PREV_SKIPPED | A previously skipped city is not |
| | in the same region as the current |
| | city |
| MATCH_PREV_SKIPPED | A previously skipped city is in |
| | the same region as the current |
| | city |
| ADDED_STOP_RATING_FACTOR | multiplier used when a city does |
| | not exist in the route and is not a |
| | major hub |
| ADDED_STOP_NEAR_REGION | A city does not exist in the route |
| | and has a hop difference |
| | <= MAX_HOP_DIFF |
| ADDED_STOP_OUT_REGION | multiplier used when a city does |
| | not exist in the route and has a |
| | hop difference |
| | > MAX_HOP_DIFF |
| OUT_OF_ORDER | multiplier used when a city's |
| | index in the fare is not the same |
| | as in the route (relative to the |
| | current city) |
| ALREADY_VISITED | There are not unvisited |
| | occurrences of the city (as city |
| | or overlandCity) in the route |
| ROUND_TRIP_FACTOR | multiplier used when the fare's |
| | stop city is in the same region |
| | as the start city of the route. |
| | Value is multiplied by the |
| | number of untouched cities |
| | remaining. |

SOURCE CODE

```
scoreFare(currentFare, tbRoute) {
  highestVisitedIndex = currentCityOffset
  workingRoute = deep copy of currentRoute
  if currentCity is in workingRoute then
    mark its routeNode visited
    add MATCH to score
  else currentCity is an Added city
    add MATCH to score
  for each airportToken in the curentFare {
    increment fareindex
    if the current airportToken == OVERLAND_CODE then
      add OVERLAND_IN_FARE to score
    else
      set currentFareCity = parent city of current airportToken
      currentRouteIndex = index of currentFareCity within
      the workingRoute
      if currentFareCity not in workingRoute then
      if currentCity's rating > 1 then
        add rating * ADDED_STOP_RATING_FACTOR to score
      set lastRegion = region of routeNode at highestVisitedIndex
      set addRegion = parent region of currentCity
      set hopCount = hopCount(lastRegion,addRegion)
      if (hopCount > MAX_HOP_COUNT)
        score += hopCount −
          MAX_HOP_COUNT)*ADDED_STOP_OUT_REGION;
      else
        score += ADDED_STOP_NEAR_REGION;
    else //currentFareCity is in workingRoute
      tempRouteNode = route node at index currentRouteIndex  \
            within workingRoute
      if tempRouteNode is visited
        score += ALREADY_VISITED;
      else
        mark tempRouteNode as visited;
        if currentRouteIndex > highestVisitedIndex
          highestVisitedIndex = tempRouteIndex;
        if currentFareIndex == currentRouteIndex -  \
                currentCityOffset
          score += MATCH;
        else
          if tempRouteIndex > currentCityOffset
            //If not previously skipped city
              score += MATCH;
          score += OUT_OF_ORDER * absolute value
            ((tempRouteIndex − currentCityOffset) −
              tempFareIndex))
          else //Previously skipped
            if currentCity.regionCode ==
              tempRouteNode.city.regionCode
            score += MATCH_PREV_SKIPPED;
            else score +=
              AVOID_PREV_SKIPPED;
      lastCity = currentFareCity
  set endFareRegion = region code of parent city of last airport code in  \
          the currentFare
  set startRouteRegion = region of first city in tbRoute
  if endFareRegion == startRouteRegion //if fare completes the trip then  \
          penalize appropriately
    set prevHighVisited = highest visited node index of tbRoute
    if prevHighVisited < index of last node in tbRoute
      for each node from highest visited index of tbRoute to the \
              end of workingRoute
          if the current node is visited
            score += ROUND_TRIP_FACTOR
  else //score skips
    for each node from currentCityOffset +1 to (highestVisitedIndex −
currentCityOffset)
      if the current node is not visited
          score += SKIPPED_ROUTE_NODE
    return score
```

What is claimed is:

1. A method of generating an itinerary using a computer, the itinerary includes nodes each representing a location accessible by a scheduled transport service, the method comprising:
receiving a specification including a plurality of nodes;
determining an itinerary that includes a first fare that omits at least one node in the plurality of nodes; and
determining a second fare that includes the node omitted in the first fare and a node included in the first fare.

2. The method of claim 1, wherein the plurality of nodes are specified in an order, wherein the first fare includes a sequence of nodes that are not in the specified order.

3. The method of claim 1, wherein the second fare includes the omitted node and a node that is before or after the omitted node in the specified order.

4. The method of claim 1, wherein at least one of the first fare and the second fare include nodes not included in the specification of the plurality of nodes.

5. The method of claim 1, wherein the plurality of nodes comprise destinations.

6. The method of claim 1, wherein the second fare comprises a round trip route for the omitted node to the node included in the first itinerary.

7. The method of claim 6, wherein the round trip route comprises arriving and departing from a different transportation hub for at least one of the omitted node and the node included in the first itinerary.

8. The method of claim 1, wherein certainty values are associated with the plurality of nodes, wherein determining the itinerary that includes a first fare that omits at least one node comprises:
using the certainty values to determine the at least one node.

9. A method for generating an itinerary using a computer, the itinerary includes nodes each representing a location accessible by a scheduled transport service, the method comprising:
receiving a specification of a plurality of nodes, the plurality of nodes specified in an order of destination;
determining a first fare that omits a node in the plurality of nodes, the first fare including a sequence of nodes that are not in the order specified; and
determining a second fare that includes the omitted node and a node in the first itinerary.

10. The method of claim 9, wherein at least one of the first and second fare include nodes that are not included in the received specification of the plurality of nodes.

11. The method of claim 9, wherein at least one of the first fare and the second fare include nodes not included in the specification of the plurality of nodes.

12. The method of claim 9, wherein the plurality of nodes comprise destinations.

13. The method of claim 9, wherein the second fare comprises a round trip route for the omitted node to the node included in the first itinerary.

14. The method of claim 9, wherein the round trip route comprises arriving and departing from a different transportation hub for at least one of the omitted node and the node included in the first itinerary.

15. The method of claim 9, wherein certainty values are associated with the plurality of nodes, wherein determining a first fare that omits the node comprises:
using the certainty values to determine the omitted node.

16. A method for generating an itinerary using a computer, the itinerary includes nodes each representing a location accessible by a scheduled transport service, the method comprising:
receiving a specification of a plurality of nodes, the plurality of nodes specified in an order of destination;
determining a first fare that includes nodes that are not in the specified order; and
determining a second fare that includes a node that was skipped in the first itinerary.

17. A method for generating an itinerary using a computer, the itinerary includes nodes each representing a location accessible by a scheduled transport service, the method comprising:
receiving a specification of a plurality of nodes;
determining, from nodes in the plurality of nodes, a replacement node that may replace a node in the plurality of nodes; and
calculating a fare for an itinerary that includes the replacement node instead of the replaced node in the specification.

18. The method of claim 17, wherein the replacement node comprises a major hub.

19. The method of claim 17, wherein the itinerary calculated with the replacement node for the specification is cheaper than an itinerary calculated for the specification with the replaced node.

20. The method of claim 17, further comprising determining a side trip fare that includes the replaced node and a node in the calculated itinerary.

21. The method of claim 17, wherein certainty values are associated with the plurality of nodes, wherein determining the replacement node comprises:
using the certainty values to determine a node to replace.
